(19) United States
(12) Patent Application Publication
(10) Pub. No.: US 2025/0293423 A1
(43) Pub. Date: Sep. 18, 2025

(54) RESONATOR, FILTER, DYNAMIC ANTENNA ELEMENT, AND REMOTE RADIO UNIT

(71) Applicant: HUAWEI TECHNOLOGIES CO., LTD., Shenzhen (CN)

(72) Inventors: Dongchun QIAO, Shanghai (CN); Yi LIU, Shenzhen (CN); Yanlin SONG, Shenzhen (CN); Guosheng PU, Yokohama (JP)

(21) Appl. No.: 19/222,061

(22) Filed: May 29, 2025

Related U.S. Application Data
(63) Continuation of application No. PCT/CN2023/127916, filed on Oct. 30, 2023.

(30) Foreign Application Priority Data
Nov. 30, 2022 (CN) 202211522769.0

(51) Int. Cl. H01P 7/10; H01P 1/20; H01P 7/06

(52) U.S. Cl. CPC H01P 7/105; H01P 1/2002; H01P 7/06

(57) ABSTRACT

A resonator includes a dielectric body including a top and bottom surface, and side walls between the top and bottom surface. The resonator further includes at least two first blind vias within the dielectric body, a through groove between at least two first blind vias, and at least one second blind via is on a side wall of the side walls between the at least two first blind vias. The at least two first blind vias extend toward the bottom surface. The at least two first blind vias are arranged in a first direction. The at least one second blind via extends from a surface of the side wall of the side walls to the through groove. An extension direction of the at least one second blind via is perpendicular to the first direction. The at least one second blind via and the through groove are separated from each other.

### CROSS-REFERENCE TO RELATED APPLICATIONS

This application is a continuation of International Application No. PCT/CN2023/127916, filed on Oct. 30, 2023, which claims priority to Chinese Patent Application No. 202211522769.0, filed on Nov. 30, 2022, the disclosures of the aforementioned applications are hereby incorporated by reference in their entireties.

### TECHNICAL FIELD

This application relates to the field of antenna technology. The disclosures of the aforementioned applications are hereby incorporated by reference in their entireties

### BACKGROUND

With development of communication technologies, especially popularization of a large-scale antenna array (massive multiple-input multiple-output) technology, a quantity of channels of a base station is increasing, and this imposes a higher requirement on a volume of a filter. A resonator is an important component of the filter, and a multimode technology has been a hot research topic because of excellent characteristics of the multimode technology. Because most of current research on a dielectric multimode is based on a native multimode with a symmetry structure, modes are not decoupled, leading to low productivity. However, it is difficult to miniaturize a multimode of some approaches, and when a volume of the resonator is reduced, performance of the resonator cannot be ensured. Therefore, how to maintain the performance of the resonator and implement miniaturization of the resonator is a problem urgently to be resolved by a person skilled in the art.

### SUMMARY

One or more embodiments of the present application provide a resonator, a filter, a dynamic antenna element, and a remote radio unit, so that performance of the resonator may be maintained when miniaturization of the resonator is implemented.

According to a first aspect, this application provides a resonator, where the resonator may include a dielectric body, and the dielectric body includes a top surface and a bottom surface that are opposite to each other and side walls disposed between the top surface and the bottom surface. At least two first blind vias are provided on the top surface, each of the first blind vias extends toward the bottom surface, and the at least two first blind vias are arranged in a first direction. A through groove is provided between any two adjacent first blind vias, at least one second blind via is provided on the side wall between the any two adjacent first blind vias, the second blind via extends from a surface of the side wall to the dielectric body, an extension direction of the second blind via is perpendicular to the first direction, and the second blind via and the through groove are spaced from each other.

In the resonator in some embodiments, each of the first blind vias forms one single-mode dielectric waveguide, that is, one first blind via forms a resonant cavity. A through groove is provided between two first blind vias, and parts that are of the dielectric body and that are located between the through groove and the first blind vias may be configured to couple energy between two resonant cavities. By providing a second blind via on a first side wall, a mode may be added to a filter from a side surface, and three resonant modes are implemented in space of the two original resonant cavities. Because the second blind via is provided on the side wall, an area occupied on the top surface may be reduced, thereby improving space utilization and implementing miniaturization of the resonator.

In some embodiments, there are two second blind vias between any two adjacent first blind vias. The two second blind vias may be symmetrically provided on two sides of the through groove in the extension direction of the second blind via. Four resonant modes are implemented in a range of the two resonant cavities, thereby further improving space utilization.

In some embodiments, the side walls may include a first side wall and a second side wall that are opposite to each other, the first side wall and the second side wall are both connected between the top surface and the bottom surface, and the first side wall and the second side wall are arranged in the extension direction of the second blind via. In the two second blind vias, one of the second blind vias is provided on the first side wall and extends toward the second side wall, and the other of the second blind vias is provided on the second side wall and extends toward the first side wall. The first side wall and the second side wall are disposed opposite to each other. This may help the resonator be of a square structure, so as to facilitate providing the two symmetric second blind vias.

In some embodiments, the any two adjacent first blind vias are symmetrically provided on two sides of the through groove between the two first blind vias. In this way, a parameter of the filter may be conveniently adjusted, so as to implement optimal performance of the filter.

In some embodiments, in the first direction, any one of the second blind vias is located at a central position between the two first blind vias. In this way, the parameter of the filter may be conveniently adjusted, so as to implement the optimal performance of the filter.

In some embodiments, a third blind via extending from the top surface to the bottom surface is further provided on the top surface, and on a plane parallel to the top surface and in the extension direction of the second blind via, the third blind via and the second blind via are separately located on the two sides of the through groove. The third blind via is provided on the top surface, and the third blind via may be used to implement negative coupling between the first blind via and the second blind via, and implement a band-pass low-end zero-point.

In some embodiments, in a direction from the top surface to the bottom surface, a depth of the third blind via is greater than a depth of the first blind via. The negative coupling between the first blind via and the third blind via may be implemented by disposing the third blind via.

In some embodiments, in the first direction, the third blind via is located at a central position between the two first blind vias. In this way, the parameter of the filter may be conveniently adjusted, so as to implement the optimal performance of the filter.

According to a second aspect, this application provides a filter, where the filter may include the resonator according to any one of the possible implementation solutions of the first aspect. The filter in this application may not only implement a miniaturization design of the filter, improve space utilization, but also maintain performance of the filter.

According to a third aspect, this application provides a dynamic antenna element, including the filter according to the second aspect. The dynamic antenna element provided in this application may improve a system capacity and three-dimensional coverage.

According to a fourth aspect, this application provides a remote radio unit, including the filter according to the second aspect. The remote radio unit provided in this application may improve a system capacity and three-dimensional coverage.

### BRIEF DESCRIPTION OF DRAWINGS

FIG. 1 is a diagram of a structure of a dynamic antenna element according to an embodiment of this application;

FIG. 2 is a diagram of a structure of a remote radio unit according to an embodiment of this application;

FIG. 3 is a diagram of a structure of a resonator according to an embodiment of this application;

FIG. 4 is a diagram of a top-view structure of the resonator in FIG. 3;

FIG. 5 is a diagram of another structure of a resonator according to an embodiment of this application;

FIG. 6 is a diagram of a top-view structure of the resonator in FIG. 5;

FIG. 7 is a schematic of an equivalent circuit of a resonator with a single blind via;

FIG. 8 is an equivalent case of the equivalent circuit in FIG. 7;

FIG. 9 is another equivalent case of the equivalent circuit in FIG. 7;

FIG. 10 is a schematic of an equivalent circuit when two blind vias are directly coupled;

FIG. 11 is a schematic of equivalent circuit conversion of the resonator in FIG. 4;

FIG. 12 is still another diagram of a structure of a resonator according to an embodiment; and

FIG. 13 is a diagram of a top-view structure of the resonator in FIG. 12.

### REFERENCE NUMERALS

10—Radio frequency unit; 11—antenna interface and digital intermediate frequency; 12—digital-to-analog conversion module; 13—radio frequency signal; 14—power amplification module; 15—filter; 20—antenna element; 30—power module; 40—remote radio unit; 41—high-speed interface module; 42—signal processing unit; 43—power amplification unit; 44—filter; 50—baseband processing unit; 60—antenna; 70—power supply module; 100—resonator; 110—dielectric body; 111—top surface; 112—bottom surface; 113—first side wall; 114—second side wall; 115—third side wall; 116—fourth side wall; 120—first blind via; 130—through groove; 140—second blind via; 150—third blind via; and 160—second blind via.

### DETAILED DESCRIPTION

Terms used in the following embodiments are merely intended to describe specific embodiments, but are not intended to limit this application. The terms “one”, “a”, “the”, “the foregoing”, “this”, and “the one” of singular forms used in this specification and the appended claims of this application are also intended to include expressions such as “one or more”, unless otherwise specified in the context clearly.

Reference to “an embodiment”, “some embodiments”, or the like described in this specification indicates that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “have”, and their variants all mean “include but are not limited to”, unless otherwise specifically emphasized in another manner.

With development of communication technologies, especially popularization of a large-scale antenna array (massive multiple-input multiple-output) technology, a quantity of channels of a base station is increasing, and this imposes a higher requirement on a volume of a filter.

In an existing single-mode dielectric waveguide technology, all frequency-loaded blind vias are on a single-side surface of a dielectric, and only deepening of the blind vias is used to implement continuing miniaturization. Deepening the blind vias causes a quality factor of a single cavity to deteriorate continuously and deteriorates loss of the filter. In addition, an existing multimode technology lacks any loading structure, for example, a blind via. This means that a physical size of the filter is completely determined by a frequency and a dielectric constant of a material. Consequently, the filter lacks potential of miniaturization and is difficult to adjust.

Therefore, how to maintain performance of the filter and implement the miniaturization of the filter is a problem urgently to be resolved by a person skilled in the art.

Based on this, embodiments of this application provide a resonator, a filter, a dynamic antenna element, and a remote radio unit, thereby reducing space occupied by the resonator to implement miniaturization, and maintaining performance of the resonator. The following describes the resonator, the filter, the dynamic antenna element, and the remote radio unit in detail with reference to specific embodiments.

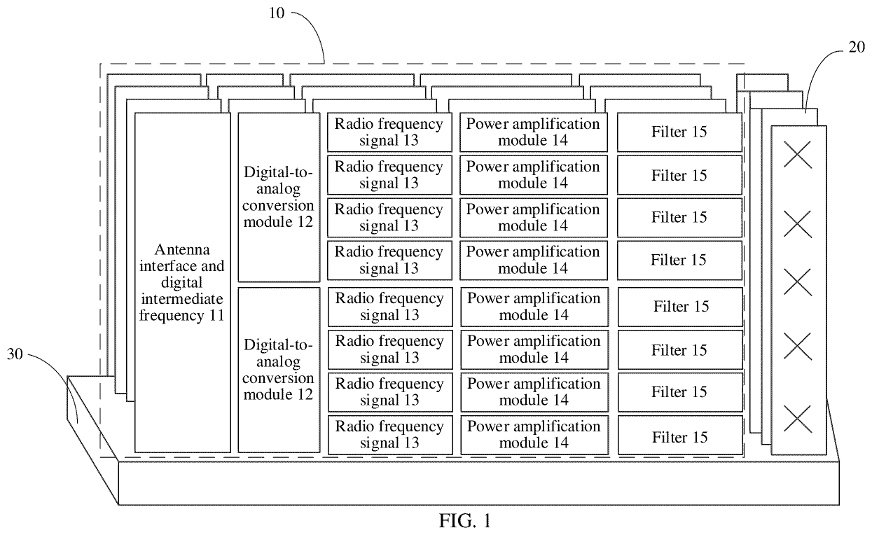

FIG. 1 is a diagram of a structure of a dynamic antenna element according to an embodiment of this application. The dynamic antenna element in this embodiment may include a radio frequency unit 10, an antenna element 20, and a power module 30, where the power module 30 may be configured to provide working voltages for the antenna element 20 and the radio frequency unit 10.

The radio frequency unit 10 may include an antenna interface and digital intermediate frequency 11, a digital-to-analog conversion module 12, a radio frequency signal 13, a power amplification module 14, and a filter 15 that are sequentially connected, where the filter 15 is connected to the antenna element 20. The radio frequency unit 10 may be configured to complete processing of uplink and downlink radio frequency signals, radio frequency channel phase correction, and the like, and the antenna element 20 may transmit and receive a radio wave by using a large-scale antenna array.

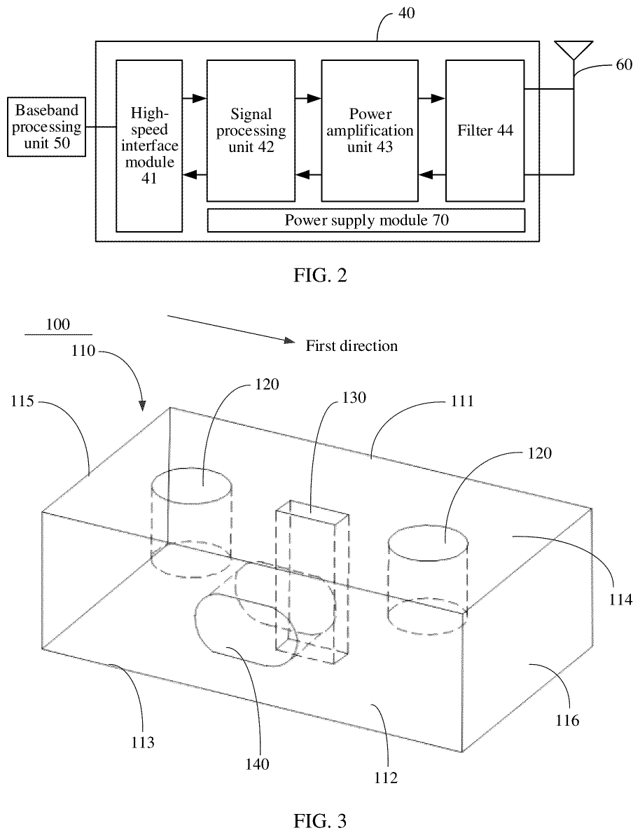

FIG. 2 is a diagram of a structure of a remote radio unit according to an embodiment of this application. The remote radio unit 40 in this embodiment may include a high-speed interface module 41, a signal processing unit 42, a power amplification unit 43, and a filter 44, where the high-speed interface module 41 may be connected to a baseband processing unit 50 through an optical fiber, and the filter 44 may be connected to an antenna 60. A radio frequency signal may be output to the remote radio unit 40 through the baseband processing unit 50, and sent to the antenna 60 after being processed by the remote radio unit 40, so as to complete transmission of the radio frequency signal. Alternatively, the antenna 60 receives a radio wave, sends the radio wave to the remote radio unit 40, and sends, to the baseband processing unit 50, a radio wave processed by the remote radio unit 40, so as to complete receiving of the radio wave.

The remote radio unit 40 may further include a power supply module 70, where the power supply module 70 may provide working voltages for the signal processing unit 42, the power amplification unit 43, and the filter 44.

FIG. 3 is a diagram of a structure of a resonator according to an embodiment of this application. The filter 15 shown in FIG. 1 or the filter 44 shown in FIG. 2 may include a resonator 100, where the resonator 100 may include a dielectric body 110, and the dielectric body 110 includes a top surface 111 and a bottom surface 112 that are opposite to each other and side walls located between the top surface 111 and the bottom surface 112. A shape of the resonator 100 in this embodiment is not limited. For example, the resonator 100 may be of a cylindrical structure. In this case, the side walls of the resonator 100 are of a structure formed by continuous arc surfaces. Alternatively, the resonator 100 may be of a square structure. In this case, the side walls of the resonator 100 are of a structure formed by sequentially connecting a plurality of side walls. Alternatively, the resonator 100 may be of a structure of another shape. Examples are not described herein one by one.

For example, the resonator 100 is of a square structure, that is, the dielectric body 110 is of a square structure. In this case, the side walls of the dielectric body may be a first side wall 113 and a second side wall 114 that are opposite to each other, and a third side wall 115 and a fourth side wall 116 that are opposite to each other. The top surface 111, the bottom surface 112, the first side wall 113, the second side wall 114, the third side wall 115, and the fourth side wall 116 form an outer surface of the dielectric body 110 through enclosing.

Two first blind vias 120 extending toward the bottom surface 112 are provided in the middle of the top surface 111, where the two first blind vias 120 are arranged in a first direction, and a through groove 130 that runs through the dielectric body 110 from the top surface 111 of the dielectric body to the bottom surface 112 of the dielectric body is provided between the two first blind vias 120, and the first direction may also be understood as an arrangement direction of the third side wall 115 and the fourth side wall 116. The first side wall 113 is provided with a second blind via 140 extending toward the second side wall 114, and in the first direction, the second blind via 140 is located between the two first blind vias 120. In addition, the second blind via 140 and the through groove 130 are spaced from each other, that is, there is a specific distance between the bottom of the second blind via 140 and the through groove 130.

It should be understood that, in the filter in this embodiment, each of the first blind vias 120 forms a single-mode dielectric waveguide, that is, one first blind via 120 forms a resonant cavity. The through groove 130 is provided between the two first blind vias 120, and parts that are of the dielectric body 110 and that are located between the through groove and the first blind vias 120 may be configured to couple energy between two resonant cavities. However, by providing the second blind via 140 on the first side wall 113, a mode may be added to the filter from a side surface, and three resonant modes are implemented in space of the original two resonant cavities (namely, space occupied by the two first blind vias 120 and the through groove 130). Because the second blind via 140 is provided on the first side wall 113, an area occupied on the top surface 111 may be reduced, thereby improving space utilization and implementing miniaturization of the filter.

In an implementation solution, the two first blind vias 120 may be symmetrically provided on two sides of the through groove 130, and the second blind via 140 may be located at a central position between the two first blind vias 120. In this way, a parameter of the filter may be conveniently adjusted, so as to implement optimal performance of the filter.

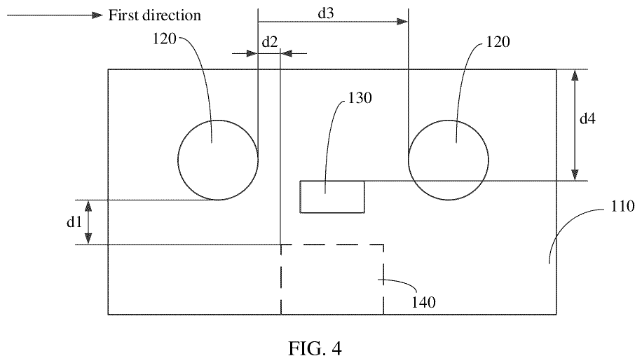

In this embodiment, frequency coupling parameters of resonant modes of the two first blind vias 120 and a resonant mode of the second blind vias 140 may be adjusted, so as to adjust an energy coupling effect. Based on this, refer to FIG. 4 that is a diagram of a top-view structure of the resonator in FIG. 3. The adjusting the frequency coupling parameters of the three resonant modes may be implemented based on the following parameters: a distance d1 between the first blind via 120 and the second blind via 140 in an arrangement direction of the first side wall 113 and the second side wall 114, a distance d2 between the first blind via 120 and the second blind via 140 in the arrangement direction of the third side wall 115 and the fourth side wall 116, a distance d3 between the two first blind vias 120, and a distance d4 between the through groove 130 and the second side wall 114 (which may also be understood as a side wall opposite to the side wall on which the second blind via 140 is provided).

In the foregoing parameters, a smaller value of d1 and/or d2 indicates a better coupling effect. A smaller value of d3 indicates a better coupling effect. A larger value of d4 indicates a better coupling effect. That is, within a specific range, a shorter distance between the second blind via 140 and the first blind via 120 indicates a better coupling effect, a shorter distance between the two first blind vias 120 indicates a better coupling effect, and a longer distance between the through groove 130 and the second side wall 114 indicates a better coupling effect. Therefore, in an actual application, optimal performance of the filter may be implemented by adjusting the foregoing parameters.

In addition, a resonance frequency may also be adjusted by adjusting a depth (namely, a size in an arrangement direction of the top surface 111 and the bottom surface 112) of the first blind via 120. Within a specific range, a smaller depth of the first blind via 120 indicates a larger resonance frequency.

In this embodiment, a shape of the first blind via 120 is not limited. For example, a shape of a cross section of the first blind via 120 may be a square, a circle, or an ellipse. Similarly, a shape of the through groove 130 is not limited either. For example, a shape of a cross section of the through groove 130 may be a square, a circle, or an ellipse. Similarly, a shape of the second blind via 140 is not limited either. For example, a shape of a cross section of the second blind via 140 may be a square, a circle, or an ellipse.

It should be noted that, in an actual application, a quantity of first blind vias 120 of the resonator 100 and a quantity of second blind vias 140 of the resonator 100 are not limited to quantities described in some embodiments. The quantity of first blind vias 120 may alternatively be three, four, five, or the like. Correspondingly, based on a requirement, a second blind via 140 may be provided between any two adjacent first blind vias 120, and a parameter of any second blind via may also be designed based on the parameter of the second blind via 140 in the foregoing embodiment. For ease of understanding, two first blind vias 120 are used as an example for description in some embodiments of this application.

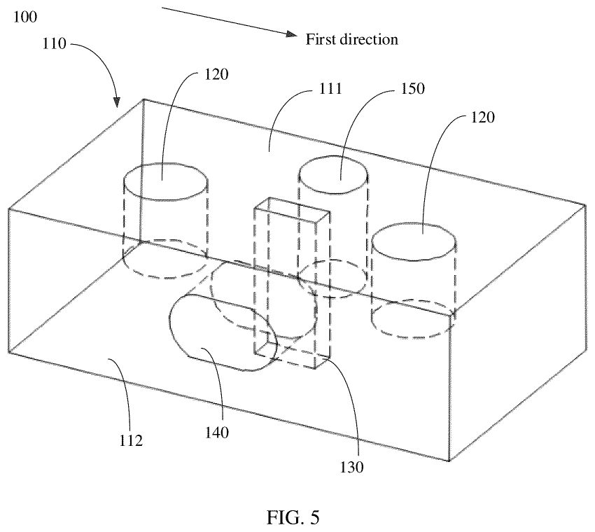

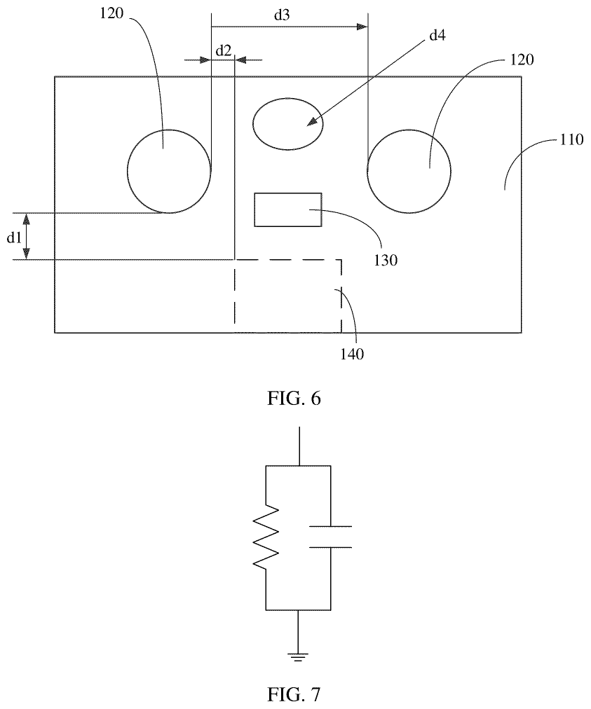

Refer to FIG. 5 and FIG. 6. FIG. 5 is still another diagram of a structure of a resonator according to an embodiment of this application, and FIG. 6 is a diagram of a top-view structure of the resonator in FIG. 5. The resonator 100 may include a dielectric body 110, where the dielectric body 110 includes a top surface 111 and a bottom surface 112 that are opposite to each other, a first side wall 113 and a second side wall 114 that are opposite to each other, and a third side wall 115 and a fourth side wall 116 that are opposite to each other. Two first blind vias 120 extending toward the bottom surface 112 are provided in the middle of the top surface 111, where the two first blind vias 120 are arranged in a first direction, and a through groove 130 that runs through the dielectric body 110 from the top surface 111 of the dielectric body to the bottom surface 112 of the dielectric body is provided between the two first blind vias 120. The first side wall 113 is provided with a second blind via extending toward the second side wall 114, and in a first direction, the second blind via 140 is located between the two first blind vias 120.

A third blind via 150 is further provided on the top surface 111, and in the first direction, the third blind via 150 is located between the two first blind vias 120. In addition, on a plane parallel to the top surface 111 and in an extension direction of the second blind via 140, the third blind via 150 and the second blind via 140 are separately located on two sides of the through groove 130. That is, the third blind via 150 is provided close to the second side wall 114. It may be understood that, compared with the resonator 100 in FIG. 3, the resonator 100 in this embodiment is added with one third blind via 150. In this embodiment, a depth of the third blind via 150 is greater than a depth of the first blind via 120. Because the third blind via 150 is located between the two first blind vias 120, the third blind via 150 may be considered as a negative coupling blind via, so as to implement negative coupling between the first blind via 120 and the second blind via 140.

In this embodiment, the two first blind vias 120 may be symmetrically provided by using the through groove 130 as a symmetry axis, where the second blind via 140 may be located at a central position between the two first blind vias 120, and the third blind via 150 may also be located at a central position between the two first blind vias 120. In this way, a parameter of a filter may be conveniently adjusted, so as to implement optimal performance of the filter.

In addition, shapes of the first blind via 120, the through groove 130, and the second blind via 140 in this embodiment may be similar to those in FIG. 3. Details are not described herein again. A shape of the third blind via 150 is not limited either. For example, a shape of a cross section of the third blind via 150 may be a square, a circle, or an ellipse.

FIG. 7 is a schematic of an equivalent circuit of a resonator with a single blind via. As shown in FIG. 7, the equivalent circuit of the resonator with the single blind via includes a capacitor and an inductor that are connected in parallel.

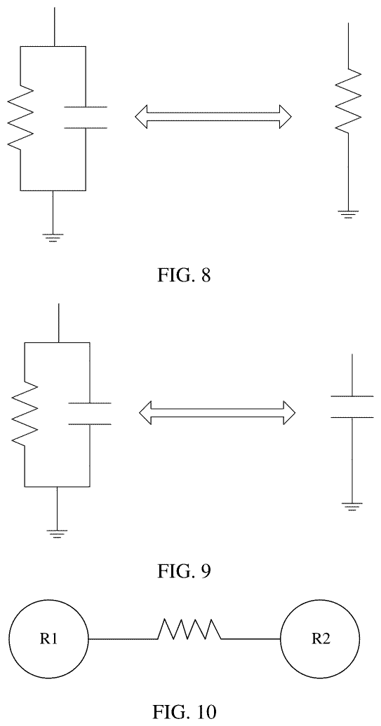

FIG. 8 is an equivalent case of the equivalent circuit in FIG. 7. For a resonator with a single blind via, when a signal frequency is lower than a resonance frequency, a resonator inductor plays a main role, and the circuit may be equivalent to a structure shown in FIG. 7.

FIG. 9 is another equivalent case of the equivalent circuit in FIG. 7. For a resonator with a single blind via, when a signal frequency is higher than a resonance frequency, a capacitor plays a main role, and the circuit may be equivalent to a structure shown in FIG. 8.

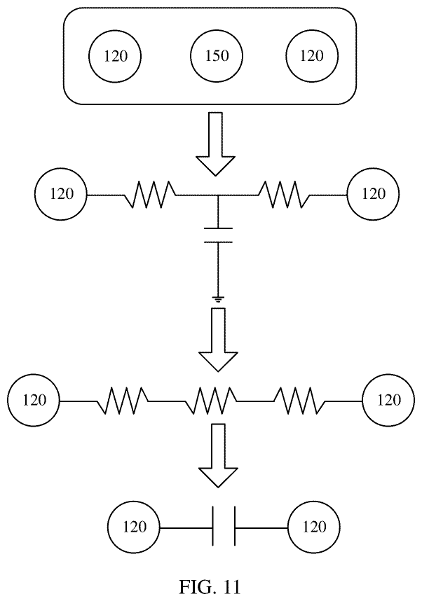

FIG. 10 is a schematic of an equivalent circuit when two blind vias are directly coupled. When two blind vias are directly coupled, a circuit may be equivalent to a series inductor as shown in FIG. 10.

FIG. 11 is a schematic of equivalent circuit conversion of the resonator in FIG. 5. Based on principles in FIG. 7 to FIG. 10, for the resonator in FIG. 4, the equivalent circuit of the resonator may be finally converted into a case in which a capacitor is connected in series between two first blind vias 120. It may be understood that, in this embodiment, a low-end zero-point of a passband may be implemented by providing the third blind via 150.

In this embodiment, still refer to FIG. 6, and performance of the resonator may be adjusted by adjusting parameters d1, d2, d3, and d5, where d5 may be understood as the depth of the third blind via 150. It may be understood that adjustment manners of d1, d2, and d3 are the same as those in FIG. 3. Details are not described herein again.

It should be noted that, when the quantity of first blind vias 120 is greater than three, a third blind via 150 may be provided between any two adjacent first blind vias 120. In addition, a parameter of any third blind via 150 may be designed with reference to the foregoing embodiments.

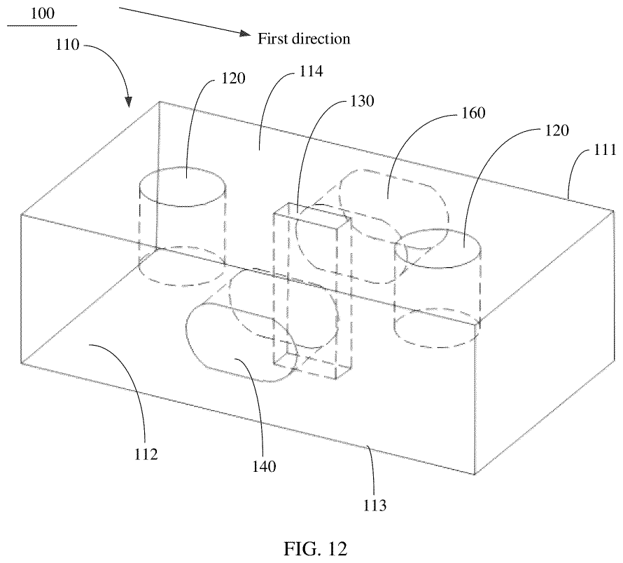

FIG. 12 is still another diagram of a structure of a resonator according to an embodiment. The resonator 100 in this embodiment may include a dielectric body 110, where the dielectric body 110 includes a top surface 111 and a bottom surface 112 that are opposite to each other, a first side wall 113 and a second side wall 114 that are opposite to each other, and a third side wall 115 and a fourth side wall 116 that are opposite to each other. Two first blind vias 120 extending toward the bottom surface 112 are provided in the middle of the top surface 111, where the two first blind vias 120 are arranged in a first direction, and a through groove 130 that runs through the dielectric body 110 from the top surface 111 of the dielectric body to the bottom surface 112 of the dielectric body is provided between the two first blind vias 120.

The first side wall 113 is provided with a second blind via 140 extending toward the second side wall 114, and in the first direction, the second blind via 140 is located between the two first blind vias 120. The second side wall 114 is provided with a second blind via 160 extending toward the first side wall 113, and in the first direction, the second blind via 160 is located between the two first blind vias 120. In addition, the second blind via 160 and the through groove 130 are spaced from each other.

It may be understood that, compared with the resonator in FIG. 3, the resonator 100 in this embodiment is added with one second blind via 160. Four resonant modes are implemented in space of original two resonant cavities, thereby further improving space utilization and implementing miniaturization of a filter.

In this embodiment, the two first blind vias 120 may be symmetrically provided on two sides of the through groove 130, and the second blind via 140 may be located at a central position between the two first blind vias 120. In addition, in an extension direction of the second blind via 140, the second blind via 140 and the second blind via 160 may also be symmetrically provided on two sides of the through groove 130. In this way, a parameter of the filter may be conveniently adjusted, so as to implement optimal performance of the filter.

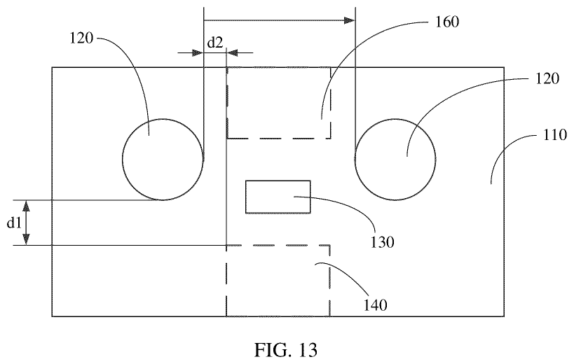

Based on this, refer to FIG. 13 that is a diagram of a top-view structure of the resonator in FIG. 12. In this embodiment, the optimal performance of the filter may be implemented by adjusting d1, d2, and d3.

It may be understood that the resonator in this application may be used in not only a filter, but also a duplexer module, or may be used in another device. This is not limited in this embodiment.

According to the resonator in this application, a resonance blind via is provided at a side wall position between two single-mode dielectric cavities, thereby improving the space utilization and implementing the miniaturization of the filter. In addition, the performance of the filter may be maintained when a volume of the filter is reduced.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A resonator, comprising:
a dielectric body comprising:
a top surface;
a bottom surface opposite from the top surface; and
side walls between the top surface and the bottom surface;
at least two first blind vias within the dielectric body, the at least two first blind vias extend from the top surface toward the bottom surface, and the at least two first blind vias are arranged in a first direction;
a through groove between at least two first blind vias; and
at least one second blind via is on a side wall of the side walls between the at least two first blind vias, the at least one second blind via extends from a surface of the side wall of the side walls to the through groove, an extension direction of the at least one second blind via is perpendicular to the first direction, and the at least one second blind via and the through groove are separated from each other.

2. The resonator according to claim 1, the at least one second blind via comprises:
two second blind vias between the at least two first blind vias, and the two second blind vias are symmetrically opposite of two opposite sides of the through groove in the extension direction.

3. The resonator according to claim 2, wherein
the side walls comprise:
a first side wall; and
a second side wall opposite from the first side wall, and the first side wall and the second side wall are arranged in the extension direction;
wherein one of the second blind vias of the two second blind vias is on the first side wall, and the other of the second blind vias of the two second blind vias is on the second side wall.

4. The resonator according to claim 1, wherein the at least two first blind vias are symmetrically opposite of two opposite sides of the through groove in the first direction.

5. The resonator according to claim 1, wherein in the first direction, the at least one second blind via is located at a central position between the at least two first blind vias.

6. The resonator according to claim 1, further comprising:
a third blind via within the dielectric body, and extending from the top surface to the bottom surface, and on a plane parallel to the top surface, the third blind via and the at least one second blind via are separately located on two opposite sides of the through groove.

7. The resonator according to claim 6, wherein in a direction from the top surface to the bottom surface, a depth of the third blind via is greater than a depth of the first blind via.

8. The resonator according to claim 6, wherein in the first direction, the third blind via is located at a central position between the at least two first blind vias.

9. A filter, comprising:
a resonator, comprising:
a dielectric body, comprising:
a top surface;
a bottom surface opposite from the top surface; and
side walls between the top surface and the bottom surface;
at least two first blind vias within the dielectric body, the at least two first blind vias extend from the top surface toward the bottom surface, and the at least two first blind vias are arranged in a first direction;
a through groove between at least two first blind vias; and
at least one second blind via is on a side wall of the side walls between the at least two first blind vias, the at least one second blind via extends from a surface of the side wall of the side walls to the through groove, an extension direction of the at least one second blind via is perpendicular to the first direction, and the at least one second blind via and the through groove are separated from each other.

10. The filter according to claim 9, the at least one second blind via comprises:
two second blind vias between the at least two first blind vias, and the two second blind vias are symmetrically opposite of two opposite sides of the through groove in the extension direction.

11. The filter according to claim 10, wherein
the side walls comprise:
a first side wall; and
a second side wall opposite from the first side wall, and the first side wall and the second side wall are arranged in the extension direction;
wherein one of the second blind vias of the two second blind vias is on the first side wall, and the other of the second blind vias of the two second blind vias is on the second side wall.

12. The filter according to claim 9, wherein the at least two first blind vias are symmetrically opposite of two opposite sides of the through groove in the first direction.

13. The filter according to claim 9, wherein in the first direction, the at least one second blind via is located at a central position between the at least two first blind vias.

14. The filter according to claim 9, further comprising:
a third blind via within the dielectric body, and extending from the top surface to the bottom surface, and on a plane parallel to the top surface, the third blind via and the at least one second blind via are separately located on two opposite sides of the through groove.

15. A dynamic antenna element, comprising:
a filter, comprising:
a resonator, comprising:
a dielectric body comprising:
a top surface;
a bottom surface opposite from the top surface; and
side walls between the top surface and the bottom surface;
at least two first blind vias within the dielectric body, the at least two first blind vias extend from the top surface toward the bottom surface, and the at least two first blind vias are arranged in a first direction;
a through groove between at least two first blind vias; and
at least one second blind via is on a side wall of the side walls between the at least two first blind vias, the at least one second blind via extends from a surface of the side wall of the side walls to the through groove, an extension direction of the at least one second blind via is perpendicular to the first direction, and the at least one second blind via and the through groove are separated from each other.

16. The dynamic antenna element according to claim 15, wherein the at least one second blind via comprises:
two second blind vias between the at least two first blind vias, and the two second blind vias are symmetrically opposite of two opposite sides of the through groove in the extension direction.

17. The dynamic antenna element according to claim 16, wherein
the side walls comprise:
a first side wall; and
a second side wall opposite from the first side wall, and the first side wall and the second side wall are arranged in the extension direction;
wherein one of the second blind vias of the two second blind vias is on the first side wall, and the other of the second blind vias of the two second blind vias is on the second side wall.

18. The dynamic antenna element according to claim 15, wherein the at least two first blind vias are symmetrically opposite of two opposite sides of the through groove in the first direction.

19. The dynamic antenna element according to claim 15, wherein in the first direction, the at least one second blind via is located at a central position between the at least two first blind vias.

20. The dynamic antenna element according to claim 15, further comprising:
a third blind via within the dielectric body, and extending from the top surface to the bottom surface, and on a plane parallel to the top surface, the third blind via and the at least one second blind via are separately located on two opposite sides of the through groove.
